(19) United States
(12) Patent Application Publication
(10) Pub. No.: US 2009/0148090 A1
(43) Pub. Date: Jun. 11, 2009

(54) Stamped inner or outer races

(75) Inventor: Nathan Daniel Hudson, Wooster, OH (US)

Correspondence Address: SIMPSON & SIMPSON, PLLC, 5555 MAIN STREET, WILLIAMSVILLE, NY, 14221-5406, US

(73) Assignee: LuK Lamellen und Kupplungsbau Beteiligungs KG, Buehl (DE)

(21) Appl. No.: 12/315,340

(22) Filed: Dec. 2, 2008

Related U.S. Application Data
(60) Provisional application No. 61/005,788, filed on Dec. 7, 2007.

(51) Int. Cl. F16C 33/64; B21K 1/04

(52) U.S. Cl. 384/492; 29/898.066

(57) ABSTRACT

An inner race or and outer race, including: a first annular portion with a first radial surface at a first end of the race; and a second annular portion formed from a same piece of material as the first portion, at least partially in contact with the first portion, the second portion having a second radial surface at the first end of the race, the second radial surface separate from the first radial surface at the first end of the race. In one embodiment, the first and second radial surfaces are substantially orthogonal to a longitudinal axis for the race. The inner race includes a third annular portion disposed at a second end of the race, opposite the first end, and formed from the same piece of material. The first and second annular portions extend from the third annular portion to the first end of the race.

### CROSS-REFERENCE TO RELATED APPLICATIONS

This application claims the benefit under 35 U.S.C. §119(e) of U.S. Provisional Application No. 61/005,788 filed on Dec. 7, 2007 which application is incorporated herein by reference.

### FIELD OF THE INVENTION

The invention relates to improvements in apparatus for transmitting force between a rotary driving unit (such as the engine of a motor vehicle) and a rotary driven unit (such as the variable-speed transmission in the motor vehicle). In particular, the invention relates to an inner or outer race formed by a stamping process.

### BACKGROUND OF THE INVENTION

An inner race, for example, for a one-way clutch or hub, formed from cast or powered metal is known in the art. Unfortunately, these races are relatively costly. It also is known to form a bearing race using stamping operations. U.S. Pat. No. 3,700,299 (Batt), U.S. Pat. No. 4,081,204 (Bauer et al.), and U.S. Pat. No. 6,176,623 (Zeigler) teach bearing races or cages from folded metal. Unfortunately, the races or cages are generally thin-walled, for example, the circumferential walls are only one layer of material thick, making the races unsuitable for a one-way clutch or hub, which can exert large radial forces on the circumferential walls. Furthermore, various curled portions on the ends of the races make the races unsuitable. For example, the portions interfere with the circumferential surfaces needed for interfacing with roller bearings or sprags in a one-way clutch.

Thus, there is a long-felt need for a means of forming an inner race, using stamping operations, having sufficient structural strength and suitable configuration for use in a one-way clutch or hub.

### BRIEF SUMMARY OF THE INVENTION

The present invention broadly comprises an inner race, including: a first annular portion with a first radial surface at a first end of the race; and a second annular portion formed from a same piece of material as the first portion, at least partially in contact with the first portion, the second portion having a second radial surface at the first end of the race, the second radial surface separate from the first radial surface at the first end of the race. In one embodiment, the first and second radial surfaces are substantially orthogonal to a longitudinal axis for the race. The inner race includes a third annular portion disposed at a second end of the race, opposite the first end, and formed from the same piece of material. The first and second annular portions extend from the third annular portion to the first end of the race.

In a first embodiment, the first and second radial surfaces are at least partially welded together. In a second embodiment, the race includes a sleeve disposed circumferentially about at least a portion of an outer surface for the race or an outer surface of the race is hardened. In one embodiment, the race is for a hub or a one-way clutch. In another embodiment, the race is formed from a stamped material. In a third embodiment, the second portion includes a section at the first end, the section extending radially outward.

The present invention broadly comprises a method of fabricating an inner race, including the steps of: blanking out a disk of material; extruding a central portion of the disk to form a neck along a longitudinal axis; flattening an end of the neck; piercing the end to form an opening; and folding, about a first longitudinal end of the race, a peripheral portion of the disk against an outer surface of the neck to form a cylinder aligned with the axis, the peripheral portion and the neck extending from the first longitudinal end of the cylinder to a second longitudinal end of the cylinder, opposite the first longitudinal end.

In one embodiment, flattening an end of the neck includes upsetting the end to thicken the end and to square a circumference of the end and the method further includes forming an outer circumferential surface of the neck to be parallel to the axis. In a first embodiment, a step hardens an outer circumferential surface of the folded peripheral portion or inserts an annular sleeve over the outer circumferential surface of the folder peripheral portion. In a second embodiment, a step welds the neck to the folded peripheral portion. In a third embodiment, a radial length of the peripheral portion is greater than an axial length of the neck and folding a peripheral portion of the disk includes folding a segment of the peripheral portion to lie orthogonal to the axis. In a fourth embodiment, a radial surface for the folded segment of the peripheral portion of the disk forms a first radial surface at the first end and the end of the neck forms a second radial surface at the first end.

The present invention broadly comprises an outer race and a method of fabricating an outer race

It is a general object of the present invention to provide a means of using stamping processes to form an inner race or an outer race from a single piece of flat material.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1A is a perspective view of a cylindrical coordinate system demonstrating spatial terminology used in the present application;

FIG. 1B is a perspective view of an object in the cylindrical coordinate system of FIG. 1A demonstrating spatial terminology used in the present application;

FIG. 2 is a front perspective view of a present invention inner race;

FIG. 3 is front view of the inner race shown in FIG. 2;

FIG. 4 is a cross-sectional view of the inner race shown in FIG. 2, generally along line 4-4 in FIG. 3;

FIG. 5 is a front perspective view of a present invention inner race with an outer sleeve;

FIG. 6 is a front perspective view of a present invention inner race with a radially extending section;

FIG. 7 is front view of the inner race shown in FIG. 6;

FIGS. 8A through 8I illustrate a present invention method of fabricating an inner race;

FIG. 9 is a front perspective view of a present invention outer race;

FIG. 10 is front view of the outer race shown in FIG. 9;

FIG. 11 is a cross-sectional view of the outer race shown in FIG. 9, generally along line 11-11 in FIG. 10;

FIG. 12 is a front perspective view of a present invention outer race with an inner sleeve; and

FIGS. 13A through 13I illustrate a present invention method of fabricating an outer race.

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

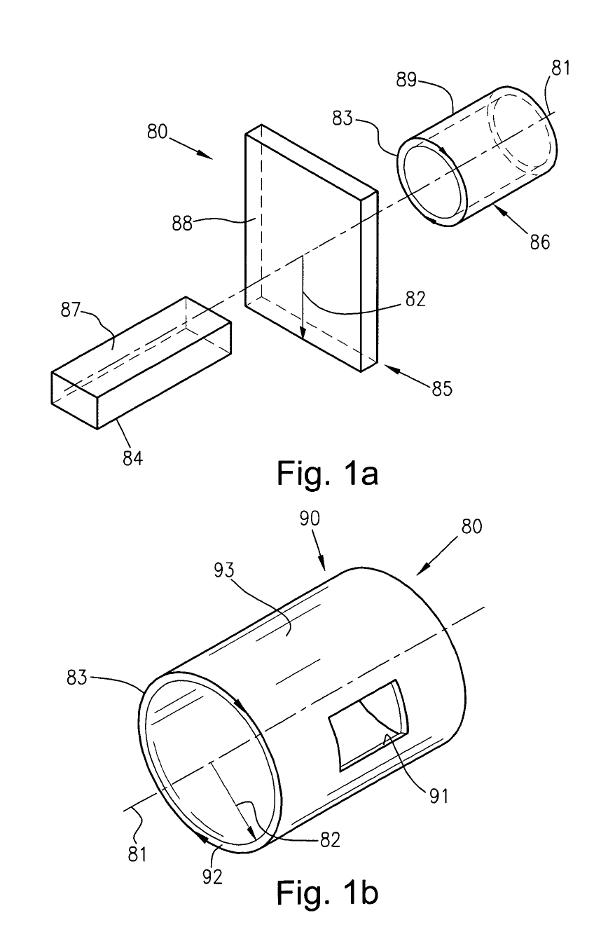

FIG. 1A is a perspective view of cylindrical coordinate system 80 demonstrating spatial terminology used in the present application. The present invention is at least partially described within the context of a cylindrical coordinate system. System 80 has a longitudinal axis 81, used as the reference for the directional and spatial terms that follow. The adjectives “axial,” “radial,” and “circumferential” are with respect to an orientation parallel to axis 81, radius 82 (which is orthogonal to axis 81), and circumference 83, respectively. The adjectives “axial,” “radial” and “circumferential” also are regarding orientation parallel to respective planes. To clarify the disposition of the various planes, objects 84, 85, and 86 are used. Surface 87 of object 84 forms an axial plane. That is, axis 81 forms a line along the surface. Surface 88 of object 85 forms a radial plane. That is, radius 82 forms a line along the surface. Surface 89 of object 86 forms a circumferential plane. That is, circumference 83 forms a line along the surface. As a further example, axial movement or disposition is parallel to axis 81, radial movement or disposition is parallel to radius 82, and circumferential movement or disposition is parallel to circumference 83. Rotation is with respect to axis 81.

The adverbs “axially,” “radially,” and “circumferentially” are with respect to an orientation parallel to axis 81, radius 82, or circumference 83, respectively. The adverbs “axially,” “radially,” and “circumferentially” also are regarding orientation parallel to respective planes.

FIG. 1B is a perspective view of object 90 in cylindrical coordinate system 80 of FIG. 1A demonstrating spatial terminology used in the present application. Cylindrical object 90 is representative of a cylindrical object in a cylindrical coordinate system and is not intended to limit the present invention in any manner. Object 90 includes axial surface 91, radial surface 92, and circumferential surface 93. Surface 91 is part of an axial plane, surface 92 is part of a radial plane, and surface 93 is part of a circumferential plane.

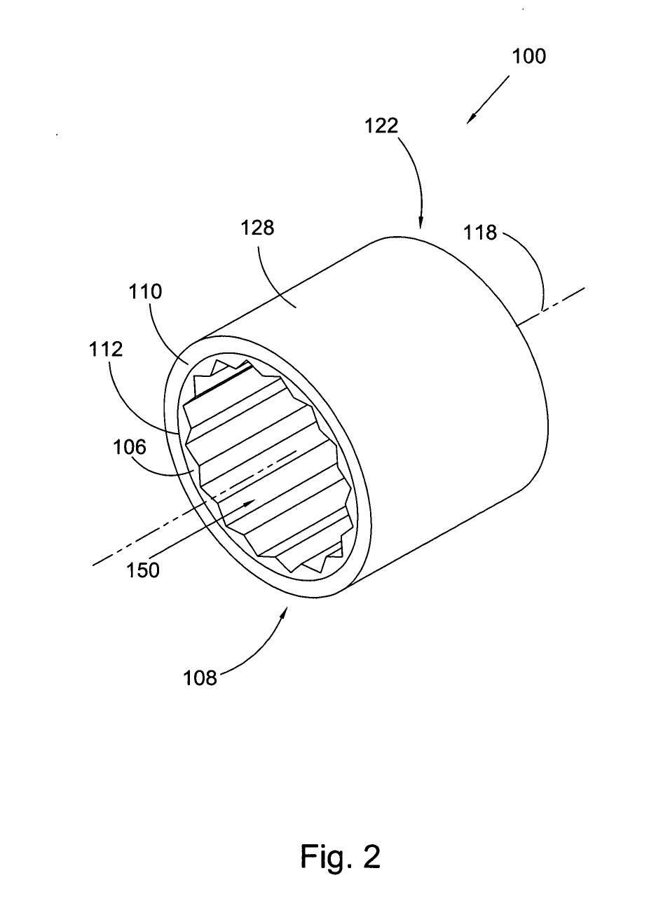

FIG. 2 is a front perspective view of present invention inner race 100.

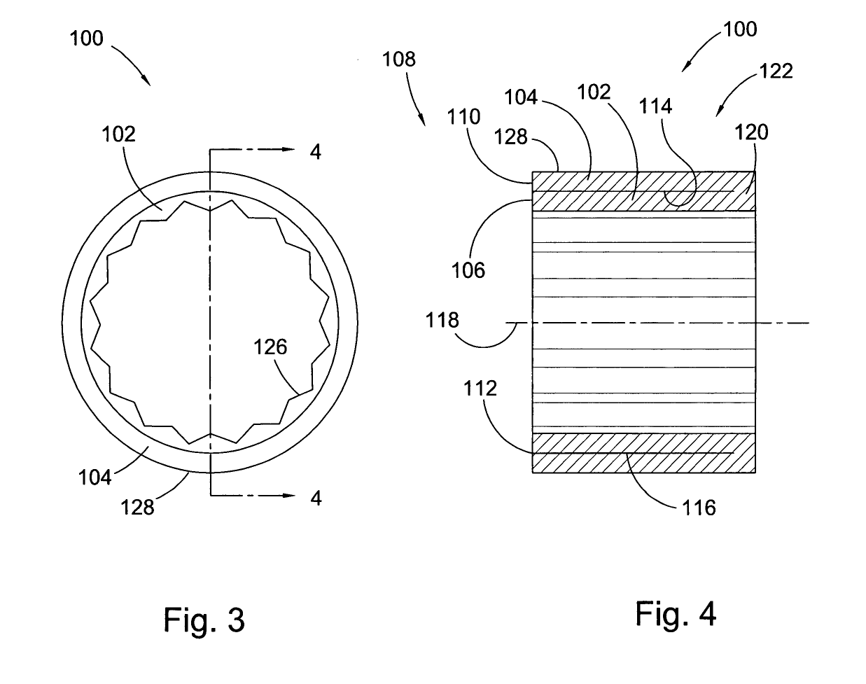

FIG. 3 is a front view of inner race 100 shown in FIG. 2.

FIG. 4 is partial cross-sectional view of inner race 100 shown in FIG. 2, generally along line 4-4 in FIG. 3. The following should be viewed in light of FIGS. 2 through 4. Inner race 100 includes annular portions 102 and 104. Portion 102 includes radial surface 106 at end 108 of the race and portion 104 includes radial surface 110 at end 108. Portions 102 and 104 are formed from the same piece of material. As described infra, the piece of material is folded upon itself to form portions 102 and 104. At end 108, the radial surfaces are separate from one another. For example, although portions 102 and 104 are formed from the same piece of material, surfaces 106 and 110 are separated by seam 112 at end 108. In one embodiment (not shown), the radial surfaces are at least partially welded together. For example, the radial surfaces are welded together along all or parts of seam 112.

Portions 102 and 104 are at least partially in contact. For example, portion 102 includes a surface 114 facing radially outward and portion 104 includes surface 116 facing radially inward. Surfaces 114 and 116 are at least partially in contact. In the preferred embodiment, surfaces 114 and 116 are pressed tightly against each other.

Alternately stated, portions 102 and 104 are circumferentially disposed about longitudinal axis 118 for the race. Portion 104 is circumferentially disposed about portion 102 and portions 102 and 104 are demarcated by seam 112.

In a preferred embodiment, radial surfaces 106 and 110 are substantially orthogonal to the longitudinal axis and radial surfaces 106 and 110 are radially aligned, that is, the surfaces are aligned with a same radial plane from the axis. It should be understood that in another embodiment, the radial surfaces 106 and 110 are not substantially orthogonal to the longitudinal axis or radial surfaces 106 and 110 are not radially aligned.

Race 100 includes annular portion 120 disposed at end 122 of the race, opposite end 108. Portion 120 is formed from the same piece of material as portions 102 and 104 and portions 102 and 104 extend from portion 120 to end 108. As described infra, during the fabrication of the race, portions 102 and 104 are folded about portion 120.

Inner surface 124 of the race can be configured in any way known in the art to enable connection to or interface with another device (not shown). For example, surface 124 can be formed with splines or teeth 126 to enable mating engagement with a shaft. In another embodiment, outer surface 128 of the race is hardened by any means known in the art.

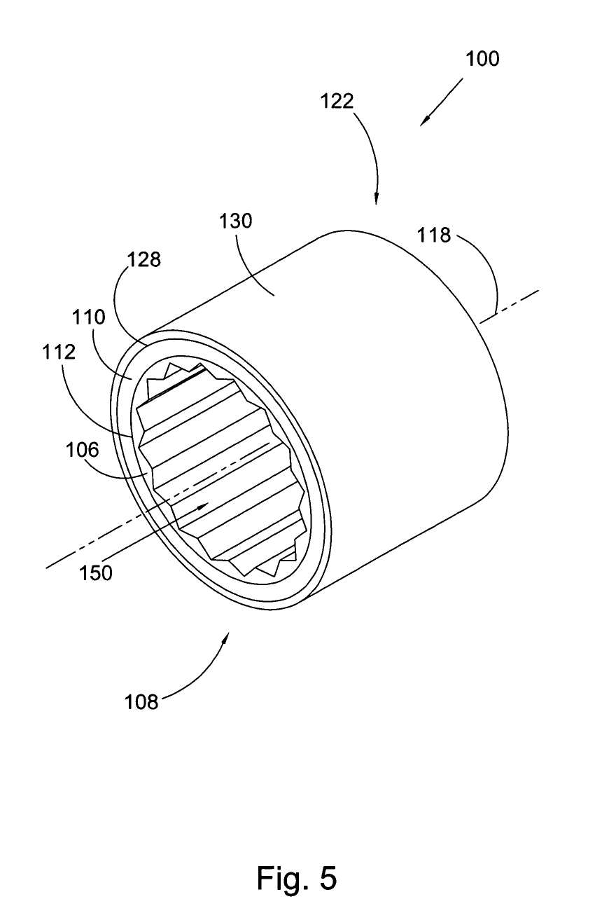

FIG. 5 is a front perspective view of present invention inner race 100 with outer sleeve 130. The following should be viewed in light of FIGS. 2 through 5. In a further embodiment, race 100 includes hardened sleeve 130 disposed circumferentially about at least a portion of outer surface 128. Thus, the sleeve is disposed about at least a portion of portion 104. The sleeve can be placed about surface 128 using any means known in the art. In general, the sleeve forms a tight frictional fit with surface 128. The sleeve is made of any hardened material known in the art. If the sleeve is placed about surface 128 prior to hardening, the sleeve can be hardened by any means known in the art after placement about surface 128.

Race 100 can be used in any applicable device known in the art. In a preferred embodiment, race 100 is used in a one-way clutch (not shown). As described infra, the race is formed using a stamping process, that is, the race is formed from a stamped material.

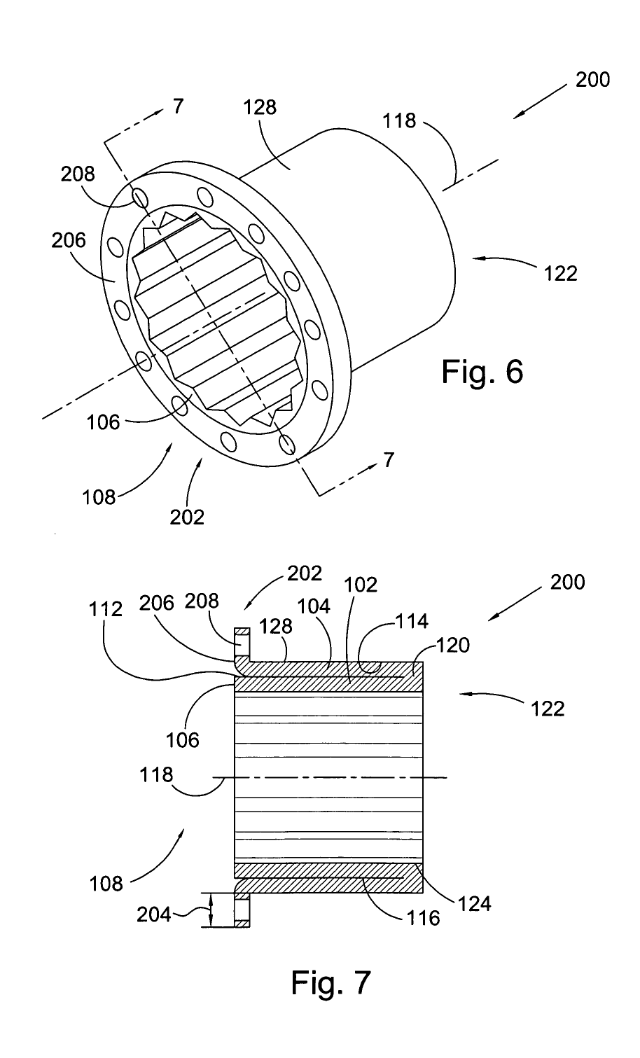

FIG. 6 is a front perspective view of present invention inner race 200 with radially extending section 202.

FIG. 7 is front view of inner race 200 shown in FIG. 6. The following should be viewed in light of FIGS. 2 through 7. In one embodiment, a present invention inner race includes a radially extending section at one longitudinal end of the race, for example, race 200 and section 202 in FIG. 7. In the discussion that follows, race 100 is modified to form portion 5 202 and hence race 200. Thus, except as noted below, the description of race 100 is generally applicable to race 200. However, it should be understood that race 200 is not limited to the features described for race 100. Portion 104 includes section 202 at end 108, extending radially outward. For example, the section extends radially outward from surface 128 and is substantially orthogonal to axis 118. In one embodiment, section 202 is a flange for race 200.

Section 202 extends radial distance 204 from surface 128. Race 200 is not limited to any particular value for distance 204. Radial surface 206 is generally analogous to surface 110 in race 100. For example, seam 112 is formed between surfaces 106 and 206. However, surface 206 is larger than surface 110 with the other respective dimensions of races 100 and 200 being substantially equal. In another embodiment, section 202 includes one or more openings 208. In a further embodiment, the openings are parallel to axis 118. Two openings 208 are shown in the figures; however, it should be understood that any number, size, and configuration of openings is within the spirit and scope of the claimed invention. In a further embodiment, a sleeve (not shown) similar to sleeve 130, is disposed about an outer surface for race 200.

Race 200 can be used in any applicable device known in the art. In a preferred embodiment, race 200 is used in a hub (not shown), for example, a turbine hub for a torque converter. As described infra, the race is formed using a stamping process, that is, the race is formed from a stamped material.

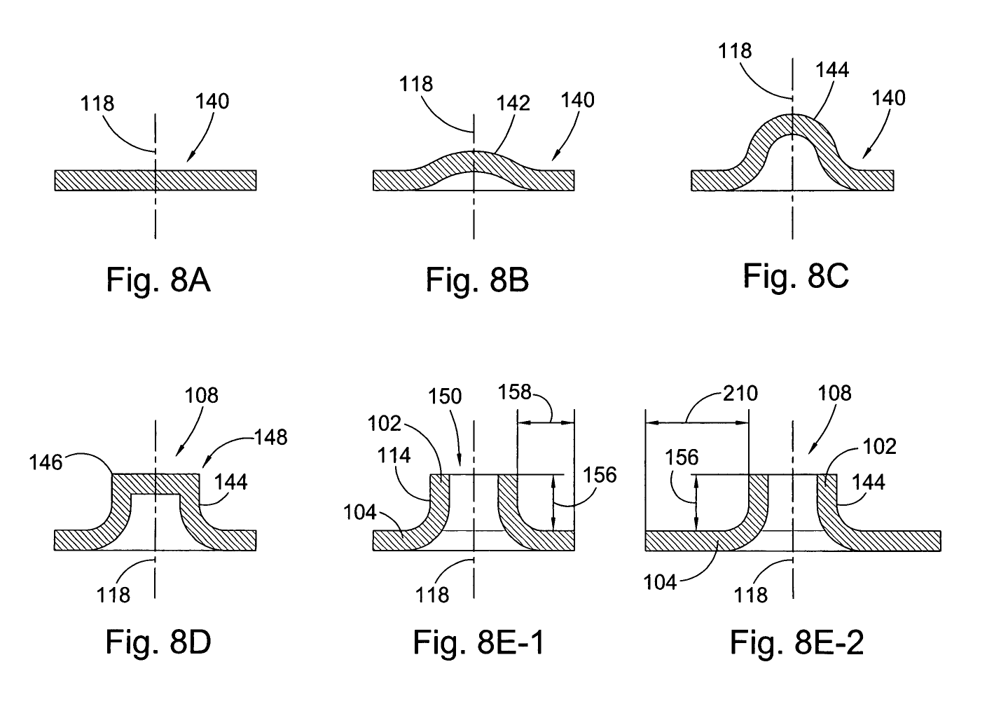

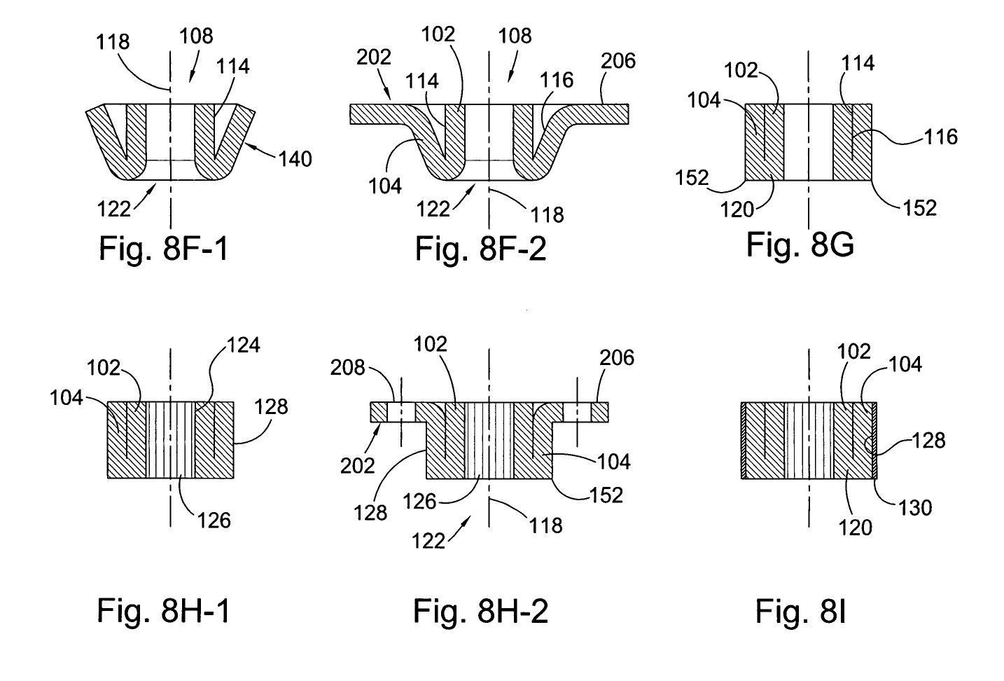

FIGS. 8A through 8I illustrate a present invention method of fabricating an inner race. The following should be viewed in light of FIGS. 2 through 8I. The present invention also comprises a method of fabricating an inner race. The method is illustrated using races 100 and 200. Although the method in FIGS. 8A through 8I is described as a sequence of steps for clarity, no order should be inferred from the sequence unless explicitly stated.

FIGS. 8A through 8I show the fabrication of race 100. A first step, as shown in FIG. 8A, blanks out a disk of material 140. A second step as shown in FIGS. 8B and 8C, extrudes central portion 142 of the disk to form neck 144 along longitudinal axis 118. In FIG. 8B, portion 142 is bubbled to begin the extrusion. In FIG. 8C, the extrusion is continued to further define the neck. In FIG. 8D, a third step flattens the neck at end 108. As part of the flattening, the end is upset to thicken corner 146 and square circumference 148. A fourth step forms outer circumferential surface 114 of the neck to be parallel to the axis as shown in FIG. 8D.

A fifth step pierces end 108 to form opening 150 as shown in FIG. 8E-1 In FIG. 8E-1, portions 102 and 104 can be identified. A sixth step folds peripheral portion 140 (which is approximately portion 104) of the disk against outer surface 114 of the neck to form a cylinder aligned with the axis as shown in FIGS. 8F-1 and 8G. The peripheral portion extends from longitudinal end 108 of the cylinder to opposite longitudinal end 122 of the cylinder. A seventh step upsets end 122 to square circumference 152 as shown in FIG. 8G. In one embodiment, an eighth step configures, or broaches, inner surface 124, for example, to form splines 126 and/or hardens outer surface 128, using any means known in the art, as shown in FIG. 8H-1. In another embodiment, a ninth step inserts annular sleeve 130 over at least a portion of outer circumferential surface 128 of the folder peripheral portion as shown in FIG. 8I. In a further embodiment, a tenth step welds the neck (portion 102) to the folded peripheral portion (portion 104). In yet another embodiment, an eleventh step surfaces 106 and 110 are operated upon, for example, ground or machined, to make the surfaces orthogonal to axis 118. The operation could occur at any point after the sixth step.

To form race 200, the steps shown in FIGS. 8A through 8D, are performed substantially as described above. Also, the piercing step is substantially the same. However, for a same dimension 156 in FIGS. 8E-1 and 8E-2, dimension 210 in FIG. 8E-2 is greater than dimension 158 in FIG. 8E-1. Alternately stated, in FIG. 8E-2, radial length 210 of the peripheral portion is greater than axial length 158 of the neck and in FIG. 8E-1, dimensions 156 and 158 are substantially equal. The folding operation with respect to portions 102 and 104 is performed in FIG. 8F-2, similar to the operation described for FIG. 8F-1; however, since dimension 210 is greater than dimension 156, section 202 extends beyond end 108. In FIG. 8F-2, portion 104 is in the process of being bent so that section 202 is radially aligning with axis 118. That is, folding a peripheral portion of the disk includes folding a segment of the peripheral portion to lie orthogonal to the axis.

The sixth step also folds the segment of peripheral portion 140 forming portion 104 against outer surface 114 of the neck to form a cylinder aligned with the axis as shown in FIG. 8G. Thus, radial surface 206 for folded segment 202 of peripheral portion 140 forms a radial surface at end 108 and the end of the neck forms radial surface 106 at end 118 as shown in FIG. 8H-2. The seventh step upsets end 122 to square circumference 152, similar to the process shown in FIG. 8G. In one embodiment, the eighth step configures, or broaches, inner surface 124, for example, to form splines 126 and/or hardens outer surface 128, using any means known in the art, as shown in FIG. 8H-2. In another embodiment, holes 208 are formed in section 202. In a further embodiment (not shown), a ninth step inserts an annular sleeve over at least a portion of outer circumferential surface 128 of the folder peripheral portion. In yet another embodiment (not shown), the tenth step welds the neck (portion 102) to the folded peripheral portion (portion 104). In a further embodiment, surfaces 106 and 206 are operated upon, for example, ground or machined, to make the surfaces orthogonal to axis 118. The operation could occur at any point after the sixth step.

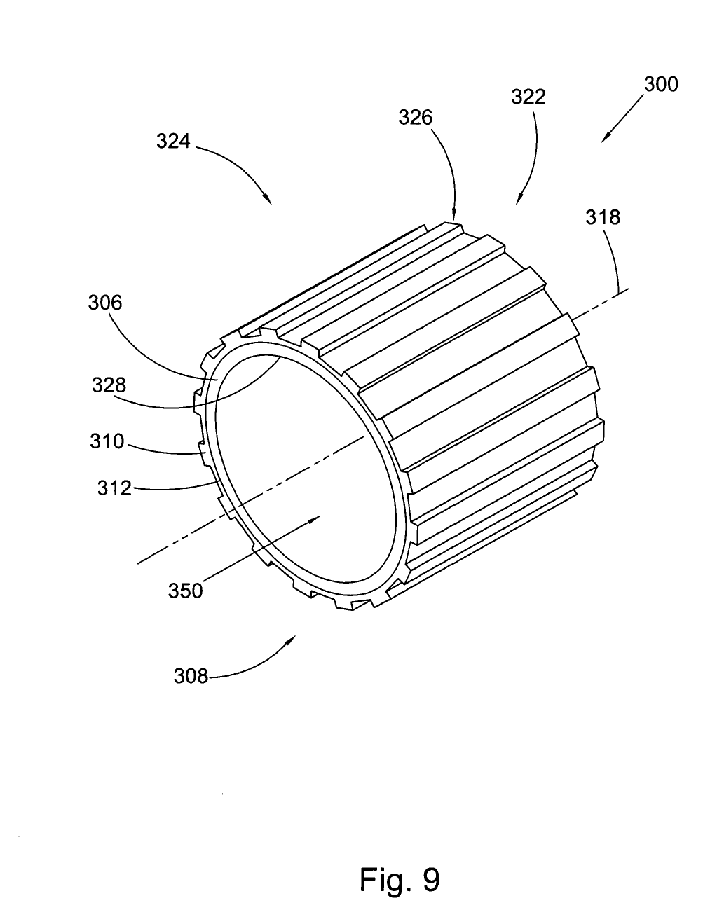

FIG. 9 is a front perspective view of present invention outer race 300.

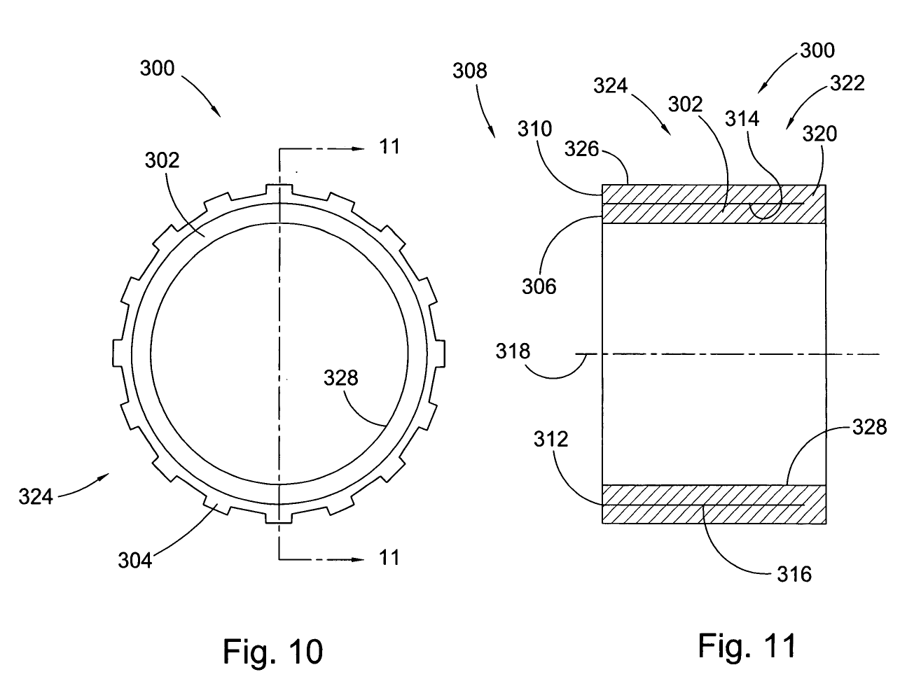

FIG. 10 is a front view of outer race 300 shown in FIG. 9.

FIG. 11 is partial cross-sectional view of outer race 300 shown in FIG. 9, generally along line 11-11 in FIG. 10. The following should be viewed in light of FIGS. 9 through 11. Outer race 300 includes annular portions 302 and 304. Portion 302 includes radial surface 306 at end 308 of the race and portion 304 includes radial surface 310 at end 308. Portions 302 and 304 are formed from the same piece of material. As described infra, the piece of material is folded upon itself to form portions 302 and 304. At end 308, the radial surfaces are separate from one another. For example, although portions 302 and 304 are formed from the same piece of material, surfaces 306 and 310 are separated by seam 312 at end 308. In one embodiment (not shown), the radial surfaces are at least partially welded together. For example, the radial surfaces are welded together along all or parts of seam 312.

Portions 302 and 304 are at least partially in contact. For example, portion 302 includes a surface 314 facing radially outward and portion 304 includes surface 316 facing radially inward. Surfaces 314 and 316 are at least partially in contact. In the preferred embodiment, surfaces 314 and 316 are pressed tightly against each other.

Alternately stated, portions 302 and 304 are circumferentially disposed about longitudinal axis 318 for the race. Portion 304 is circumferentially disposed about portion 302 and portions 302 and 304 are demarcated by seam 312.

In one embodiment, radial surfaces 306 and 310 are substantially orthogonal to the longitudinal axis and radial surfaces 306 and 310 are radially aligned, that is, the surfaces are aligned with a same radial plane from the axis. It should be understood that in another embodiment, the radial surfaces 306 and 310 are not substantially orthogonal to the longitudinal axis or radial surfaces 306 and 310 are not radially aligned.

Race 300 includes annular portion 320 disposed at end 322 of the race, opposite end 308. Portion 320 is formed from the same piece of material as portions 302 and 304 and portions 302 and 304 extend from portion 320 to end 308. As described infra, during the fabrication of the race, portions 302 and 304 are folded about portion 320.

Outer surface 324 of the race can be configured in any way known in the art to enable connection to or interface with another device (not shown). For example, surface 324 can be formed with lugs or teeth 326 to enable mating engagement with a shaft or other rotating element. In another embodiment, inner surface 328 of the race is hardened by any means known in the art.

FIG. 12 is a front perspective view of present invention outer race 300 with inner sleeve 330. The following should be viewed in light of FIGS. 9 through 12. In a further embodiment, race 300 includes hardened sleeve 330 disposed radially within at least a portion of inner surface 328 and in contact with surface 328. Thus, the sleeve is disposed about at least a portion of portion 302. The sleeve can be placed in contact with surface 328 using any means known in the art. In general, the sleeve forms a tight frictional fit with surface 328. The sleeve is made of any hardened material known in the art. If the sleeve is placed about surface 328 prior to hardening, the sleeve can be hardened by any means known in the art after placement about surface 328.

Race 300 can be used in any applicable device known in the art. In one embodiment, race 300 is used in a one-way clutch (not shown). As described infra, the race is formed using a stamping process, that is, the race is formed from a stamped material.

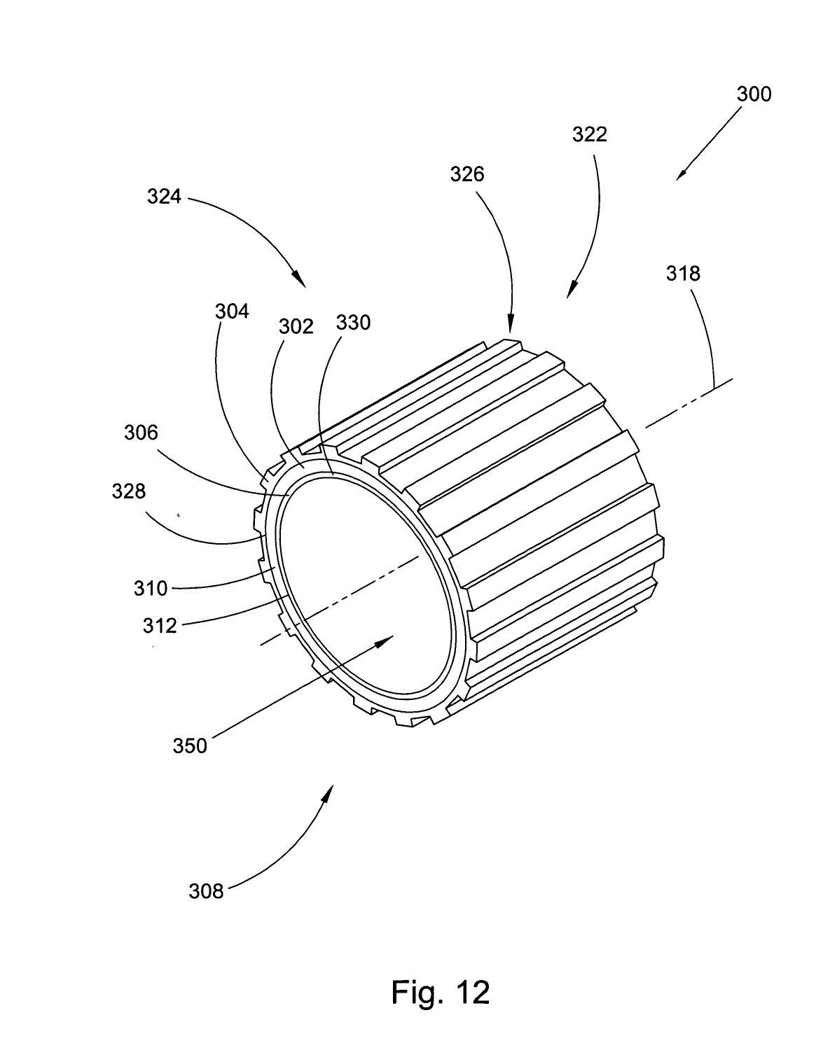

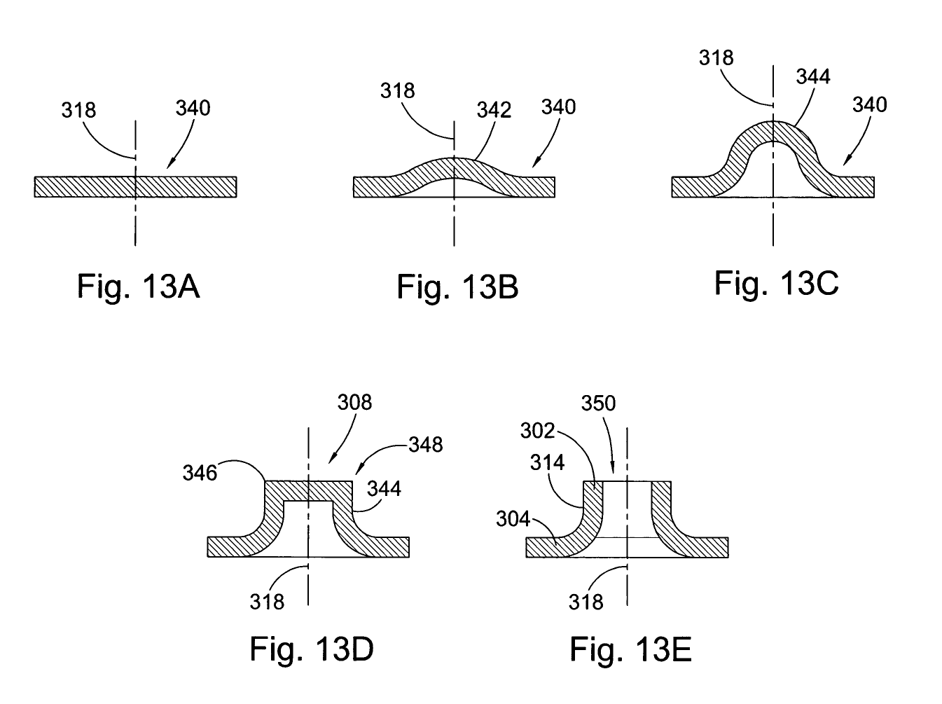

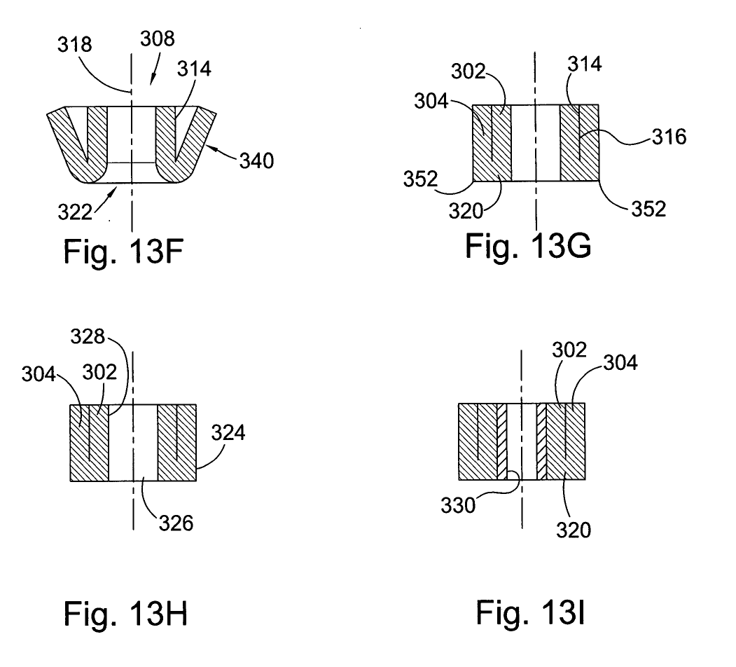

FIGS. 13A through 13I illustrate a present invention method of fabricating an outer race. The following should be viewed in light of FIGS. 9 through 13I. The present invention also comprises a method of fabricating an outer race. The method is illustrated using race 300. Although the method in FIGS. 13A through 13I is described as a sequence of steps for clarity, no order should be inferred from the sequence unless explicitly stated.

FIGS. 13A through 13I show the fabrication of race 300. A first step, as shown in FIG. 13A, blanks out a disk of material 340. A second step as shown in FIGS. 13B and 13C, extrudes central portion 342 of the disk to form neck 344 along longitudinal axis 318. In FIG. 13B, portion 342 is bubbled to begin the extrusion. In FIG. 13C, the extrusion is continued to further define the neck. In FIG. 13D, a third step flattens the neck at end 308. As part of the flattening, the end is upset to thicken corner 346 and square circumference 348. A fourth step forms outer circumferential surface 314 of the neck to be parallel to the axis as shown in FIG. 13D.

A fifth step pierces end 308 to form opening 350 as shown in FIG. 13E In FIG. 13E, portions 302 and 304 can be identified. A sixth step folds peripheral portion 340 (which is approximately portion 304) of the disk against outer surface 314 of the neck to form a cylinder aligned with the axis as shown in FIGS. 13F and 13G. The peripheral portion extends from longitudinal end 308 of the cylinder to opposite longitudinal end 322 of the cylinder. A seventh step upsets end 322 to square circumference 352 as shown in FIG. 13G. In one embodiment, an eighth step configures, or broaches, outer surface 324, for example, to form lugs or teeth 326 and/or hardens inner surface 328, using any means known in the art, as shown in FIG. 13H. In another embodiment, a ninth step inserts annular sleeve 330 over at least a portion of inner circumferential surface 328 of the folder peripheral portion as shown in FIG. 13I. In a further embodiment, a tenth step welds the neck (portion 302) to the folded peripheral portion (portion 304). In yet another embodiment, an eleventh step surfaces 306 and 310 are operated upon, for example, ground or machined, to make the surfaces orthogonal to axis 318. The operation could occur at any point after the sixth step.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

What we claim is:

1. An inner race, comprising:
a first annular portion with a first radial surface at a first end of the race; and,
a second annular portion formed from a same piece of material as the first portion, at least partially in contact with the first portion, the second portion having a second radial surface at the first end of the race, the second radial surface separate from the first radial surface at the first end of the race.

2. The inner race of claim 1 including a third annular portion disposed at a second end of the race, opposite the first end, and formed from the same piece of material, wherein the first and second annular portions extend from the third annular portion to the first end of the race.

3. The inner race of claim 1 including a sleeve disposed circumferentially about at least a portion of an outer surface for the race or wherein an outer surface of the race is hardened.

4. The inner race of claim 1 wherein the race is for a hub or a one-way clutch.

5. The inner race of claim 1 wherein the second portion includes a section at the first end, the section extending radially outward.

6. An inner race, comprising:
a first portion circumferentially disposed about a longitudinal axis for the race;
a second portion circumferentially disposed about the first portion and formed from a same piece of material as the first portion; and,
a seam between the first and second portions at a first longitudinal end for the race.

7. The inner race of claim 6 including a third portion formed from the same piece of material as the first and second portions, connected to the first and second portions and disposed at a second longitudinal end for the race, opposite the first longitudinal end.

8. The inner race of claim 7 wherein the first and second portions extend from the first longitudinal end to the third portion.

9. The inner race of claim 6 including a sleeve disposed circumferentially about at least a portion of the second portion or wherein an outer surface of the race is hardened.

10. The inner race of claim 6 wherein the race is for a hub or a one-way clutch.

11. The inner race of claim 6 wherein the second portion includes a section at the first end, the section extending radially outward.

12. A method of fabricating an inner race, comprising the steps of:
blanking out a disk of material;
extruding a central portion of the disk to form a neck along a longitudinal axis;
flattening an end of the neck;
piercing the end to form an opening; and,
folding, about a first longitudinal end of the race, a peripheral portion of the disk against an outer surface of the neck to form a cylinder aligned with the axis, the peripheral portion and the neck extending from the first longitudinal end of the cylinder to a second longitudinal end of the cylinder, opposite the first longitudinal end.

13. The method of claim 12 wherein flattening an end of the neck includes upsetting the end to thicken the end and to square a circumference of the end, and the method further including forming an outer circumferential surface of the neck to be parallel to the axis.

14. The method of claim 12 including the step of hardening an outer circumferential surface of the folded peripheral portion or inserting an annular sleeve over the outer circumferential surface of the folder peripheral portion.

15. The method of claim 12 wherein a radial length of the peripheral portion is greater than an axial length of the neck and folding a peripheral portion of the disk includes folding a segment of the peripheral portion to lie orthogonal to the axis.

16. The method of claim 12 wherein a radial surface for the folded segment of the peripheral portion of the disk forms a first radial surface at the first end and the end of the neck forms a second radial surface at the first end.

17. An outer race, comprising:
a first annular portion with a first radial surface at a first end of the race; and,
a second annular portion formed from a same piece of material as the first portion, at least partially in contact with the first portion, the second portion having a second radial surface at the first end of the race, the second radial surface separate from the first radial surface at the first end of the race.

18. The outer race of claim 17 including a third annular portion disposed at a second end of the race, opposite the first end, and formed from the same piece of material, wherein the first and second annular portions extend from the third annular portion to the first end of the race.

19. The outer race of claim 17 including a sleeve disposed radially within at least a portion of an inner surface for the race or wherein an inner surface of the race is hardened.

20. The outer race of claim 17 wherein the race is for a hub or a one-way clutch.

21. An outer race, comprising:
a first portion circumferentially disposed about a longitudinal axis for the race;
a second portion circumferentially disposed about the first portion and formed from a same piece of material as the first portion; and,
a seam between the first and second portions at a first longitudinal end for the race.

22. The outer race of claim 21 including a third portion formed from the same piece of material as the first and second portions, connected to the first and second portions and disposed at a second longitudinal end for the race, opposite the first longitudinal end.

23. The outer race of claim 22 wherein the first and second portions extend from the first longitudinal end to the third portion.

24. The outer race of claim 21 including a sleeve disposed radially within at least a portion of the second portion or wherein an outer surface of the race is hardened.

25. The outer race of claim 21 wherein the race is for a hub or a one-way clutch.

26. A method of fabricating an outer race, comprising the steps of:
blanking out a disk of material;
extruding a central portion of the disk to form a neck along a longitudinal axis;
flattening an end of the neck;
piercing the end to form an opening; and,
folding, about a first longitudinal end of the race, a peripheral portion of the disk against an outer surface of the neck to form a cylinder aligned with the axis, the peripheral portion and the neck extending from the first longitudinal end of the cylinder to a second longitudinal end of the cylinder, opposite the first longitudinal end.

27. The method of claim 26 wherein flattening an end of the neck includes upsetting the end to thicken the end and to square a circumference of the end, and the method further including forming an outer circumferential surface of the neck to be parallel to the axis.

28. The method of claim 26 including the step of hardening an inner circumferential surface of the folded peripheral portion or inserting an annular sleeve within an inner circumferential surface of the folder peripheral portion.

29. An inner race or an outer race, comprising:
a first annular portion with a first radial surface at a first end of the race; and,
a second annular portion formed from a same piece of material as the first portion, at least partially in contact with the first portion, the second portion having a second radial surface at the first end of the race, the second radial surface separate from the first radial surface at the first end of the race.
